(19) United States
(12) Patent Application Publication
(10) Pub. No.: US 2014/0125349 A1
(43) Pub. Date: May 8, 2014

(54) ELECTROMETER CURRENT INJECTION BY HIGH VOLTAGE RAMP

(71) Applicant: GENERAL ELECTRIC COMPANY, Schenectady, NY (US)

(72) Inventor: Dan Jay McCormick, Hudson, OH (US)

(73) Assignee: General Electric Company, Schenectady, NY (US)

(21) Appl. No.: 13/670,680

(22) Filed: Nov. 7, 2012

(51) Int. Cl. G01N 27/62

(52) U.S. Cl. 324/459

(57) ABSTRACT

An apparatus and method for conducting a test cycle for an electrometer of an environmental radiation monitor by current injection is provided. The environmental radiation monitor includes a high pressure ionization chamber, a power supply electrically connected to the high pressure ionization chamber, and an electrometer electrically connected to the high pressure ionization chamber. A controller controls the power supply voltage signal provided to the high pressure ionization chamber to create a constant current to be injected into the electrometer. The methods include varying the voltage signal provided to the high pressure ionization chamber, measuring a current signal, processing the current signal with the electrometer and comparing the voltage signal to an expected result, indicating proper operation of the electrometer. Further examples of the method include initiating and discontinuing a test function.

### BACKGROUND OF THE INVENTION

1. Field of the Invention

The invention relates to testing of electrometer proper operation, and specifically relates to testing of electrometer proper operation/responsiveness in environmental gamma radiation monitors.

2. Discussion of Prior Art

Electrometers are used to convert relatively low amperage current signals to voltage signals for processing. In one example, electrometers can be used to convert the low amperage current signals from the output of a high pressure ionization chamber of an environmental radiation monitor. In one example, one or more environmental radiation monitors can be deployed in the field proximate to known radiation sources such as nuclear power generation stations to monitor radiation levels. Of course, environmental radiation monitors can be deployed anywhere that it is desirable to monitor radiation levels.

It is often desirable to test the electrometer for proper response so that end users of the environmental radiation monitor can be made aware of potentially incorrect environmental radiation data caused by an electrometer operating improperly or completely failing. Electrometers can be tested by injecting a constant current into the electrometer and measuring the electrometer for an expected constant voltage reading. However, equipment designed to inject current into an electrometer at relatively small magnitude current values can be expensive. Also, such expensive test equipment is typically only used in a laboratory setting and may be impractical to install within a working radiation monitor.

Typical environmental radiation monitors have power supplies that supply only a fixed voltage signal, as a fixed voltage signal is preferred during typical operation of the radiation monitor. In one example, the power supply provides a constant 400 volt signal to the high pressure ionization chamber. It would be inventive and beneficial to use the high pressure ionization chamber included in the environmental radiation monitor to create a constant current of relatively small magnitude by ramping the rate of voltage input into the high pressure ionization chamber. Therefore, there is a need for an improved apparatus and method for injecting small magnitude currents into an electrometer for testing purposes.

### BRIEF DESCRIPTION OF THE INVENTION

The following summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

One aspect of the invention provides an environmental radiation monitor including a high pressure ionization chamber. The environmental radiation monitor further includes a power supply electrically connected to the high pressure ionization chamber. The power supply is configured to provide an input voltage signal to the high pressure ionization chamber. The environmental radiation monitor also includes an electrometer electrically connected to the high pressure ionization chamber. The environmental radiation monitor still further includes a controller electrically connected to the power supply and the electrometer. The controller is configured to control the power supply input voltage signal provided to the high pressure ionization chamber.

Another aspect of the invention provides a method of conducting a test cycle for an electrometer of an environmental radiation monitor. The method includes providing an environmental radiation monitor. The environmental radiation monitor includes a high pressure ionization chamber and a power supply electrically connected to the high pressure ionization chamber The power supply is configured to provide an input voltage signal to the high pressure ionization chamber. The environmental radiation monitor further includes an electrometer electrically connected to the high pressure ionization chamber. The environmental radiation monitor also includes a controller electrically connected to the power supply and the electrometer. The controller is configured to control the power supply input voltage signal provided to the high pressure ionization chamber. The method further includes varying the input voltage signal provided to the high pressure ionization chamber. The method still further includes measuring a current signal produced by the high pressure ionization chamber. The method also includes processing the current signal with the electrometer. The method further includes measuring an output voltage signal produced by the electrometer. The method still further includes comparing the output voltage signal to an expected result. The comparison indicates proper operation of the electrometer.

Another aspect of the invention provides a method of conducting a test cycle for an electrometer of an environmental radiation monitor. The method includes providing an environmental radiation monitor. The environmental radiation monitor includes a high pressure ionization chamber and a power supply electrically connected to the high pressure ionization chamber. The power supply is configured to provide an input voltage signal to the high pressure ionization chamber. The environmental radiation monitor further includes an electrometer electrically connected to the high pressure ionization chamber. The environmental radiation monitor also includes a controller electrically connected to the power supply and the electrometer. The controller is configured to control the power supply input voltage signal provided to the high pressure ionization chamber. The method also includes initiating the test function. The test function requires the controller to process a set of incoming data differently than when the test function is not initiated. The method further includes varying the input voltage signal provided to the high pressure ionization chamber. The method still further includes measuring a current signal produced by the high pressure ionization chamber. The method also includes processing the current signal with the electrometer. The method further includes measuring an output voltage signal produced by the electrometer. The method still further includes comparing the output voltage signal to an expected result. The comparison indicates proper operation of the electrometer. The method also includes discontinuing the test function.

### BRIEF DESCRIPTION OF THE DRAWINGS

The foregoing and other aspects of the invention will become apparent to those skilled in the art to which the invention relates upon reading the following description with reference to the accompanying drawings, in which:

FIG. 1 is a schematic isometric view of an example environmental radiation monitor in an example arrangement with associated equipment to be used in a field application;

FIG. 2 is a schematic isometric view of the environmental radiation monitor of FIG. 1 with a lid opened;

FIG. 3 is a schematic electrical diagram of an example controller and power supply shown with a high pressure ionization chamber as used in the environmental radiation monitor of FIG. 1;

FIG. 4 is a graph showing the relationship between the ramp rate of an input voltage signal produced by a power supply and the output of an example electrometer; and

FIG. 5 is a top level flow diagram of an example method of conducting a test cycle for an electrometer of an environmental radiation monitor for an environmental radiation monitor.

### DETAILED DESCRIPTION OF THE INVENTION

Example embodiments that incorporate one or more aspects of the invention are described and illustrated in the drawings. These illustrated examples are not intended to be a limitation on the invention. For example, one or more aspects of the invention can be utilized in other embodiments and even other types of devices. Moreover, certain terminology is used herein for convenience only and is not to be taken as a limitation on the invention. Still further, in the drawings, the same reference numerals are employed for designating the same elements.

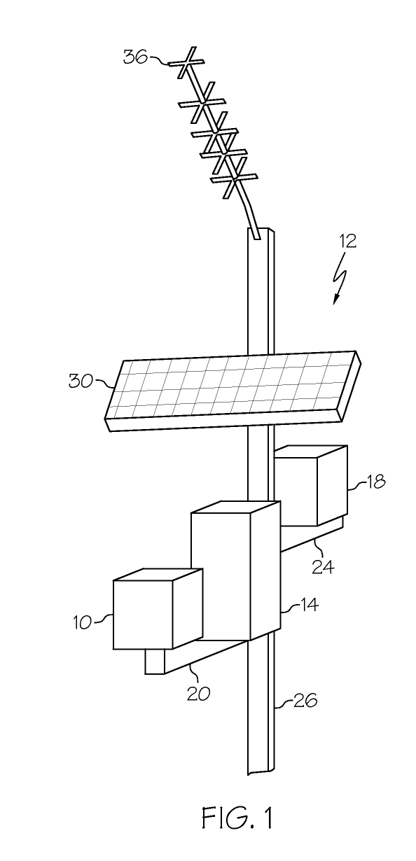

An example embodiment of an environmental radiation monitor 10 is schematically shown within FIG. 1. The environmental radiation monitor 10 is shown in one example arrangement 12 with associated equipment in a field application. It is to be appreciated that FIG. 1 merely shows one example of possible structures/configurations/etc. and that other examples are contemplated within the scope of the present invention. Generally, such an arrangement 12 is placed at an exterior location so that the environmental radiation monitor 10 can perform the function of monitoring low-level gamma radiation in the local area atmosphere. It is to be appreciated that the gamma radiation may be from known or, at times, unknown sources.

The arrangement 12 can include associated equipment, such as a controls package located within a protective enclosure 14. Such other, associated equipment operates in conjunction with the environmental radiation monitor 10. An external power supply, such as a battery located within a protective enclosure 18, can also be provided within the arrangement 12. The power supply can be used to provide power within the arrangement 12, including possible use by the environmental radiation monitor 10. The environmental radiation monitor 10, the controls package located within a protective enclosure 14, and the external power supply located within a protective enclosure 18 can be located upon any structural configuration. Within the shown example, these portions of the arrangement 12 are located on first and second arms 20 and 24 extending from a central post 26. The central post 26 serves as a firm support for the operating equipment while anchoring the arrangement 12 at a desired location.

Additional associated equipment of the arrangement 12 may include a solar panel array 30. The solar panel array 30 can be configured to supply an electrical charge to the external power supply, such as a battery. Communication equipment, including an antenna 36, can also be provided within arrangement 12 to permit communication between the controls package and a remotely located device/network/etc. (not shown). For example, the antenna 36 can transmit a signal conveying acquired data from the environmental radiation monitor 10 and receive software updates from the remotely located device/network/etc.

It is to be appreciated that the arrangement 12 shown in FIG. 1 is not limiting and other arrangements are also contemplated. For example, the environmental radiation monitor 10 and associated equipment can be housed within an enclosed structure that is typical of structures housing meteorological measuring equipment. At least one wall or door of the enclosed structure can include louvers to permit a free exchange of air between the interior and the exterior of the enclosed structure. In another example, the environmental radiation monitor 10 and associated equipment can be located on a mobile device. The environmental radiation monitors 10 can be used in a number of different arrangements 12 and the environmental radiation monitors 10 can be used individually or in plurality to measure various aspects of environmental radiation levels such as flow path, concentration, etc.

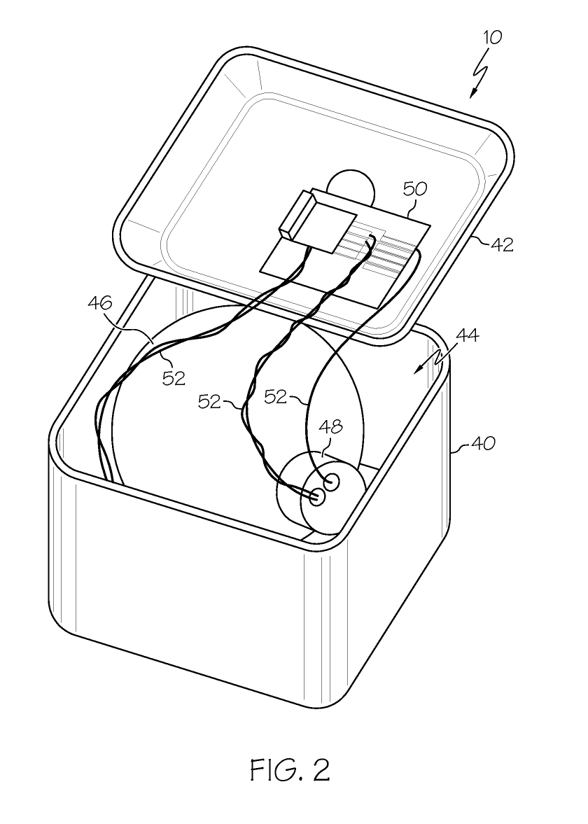

Turning to FIG. 2, an example schematic representation of the environmental radiation monitor 10 is shown. The environmental radiation monitor 10 can include a protective enclosure 40 including a lid 42. While not shown, the lid 42 can be attached to the enclosure 40 in any number of ways including, but not limited to, hinges, latches, press fit, etc. The enclosure 40 includes an interior volume 44 that provides space for individual components of the environmental radiation monitor 10. One or more of the mating surfaces of the enclosure 40 and the lid 42 can be provided with seals. It is to be appreciated that the interior volume 44 of the enclosure 40 can be sealed so that little or no ambient atmosphere can enter the protective enclosure 40 during field deployment of the environmental radiation monitor 10. In addition to protection from atmospheric conditions such as humidity, the enclosure 40 and the lid 42 can also help protect the environmental radiation monitor 10 from physical damage. Protection from physical damage during handling or deployment can be provided by an amount of cushion material (not shown for clarity purposes) within the interior volume 44. The cushion material can include expanded polystyrene, foam rubber, or any number of other materials that tend to reduce the effects of impact, rapid deceleration, etc.

The schematic representation of the environmental radiation monitor 10 shown in FIG. 2 includes one possible arrangement of some individual components of the environmental radiation monitor 10. A high pressure ionization chamber 46 is located within the interior volume 44. The high pressure ionization chamber 46 is configured to create an output of a current signal proportional to the amount of gamma radiation passing into the high pressure ionization chamber 46. The exterior wall of the high pressure ionization chamber 46 can include an attached electrometer enclosure 48 configured to contain electronic circuitry that will be described below. One or both of the high pressure ionization chamber 46 and the electronic circuitry within the electrometer enclosure 48 can be electrically connected to a controller 50 through lines 52.

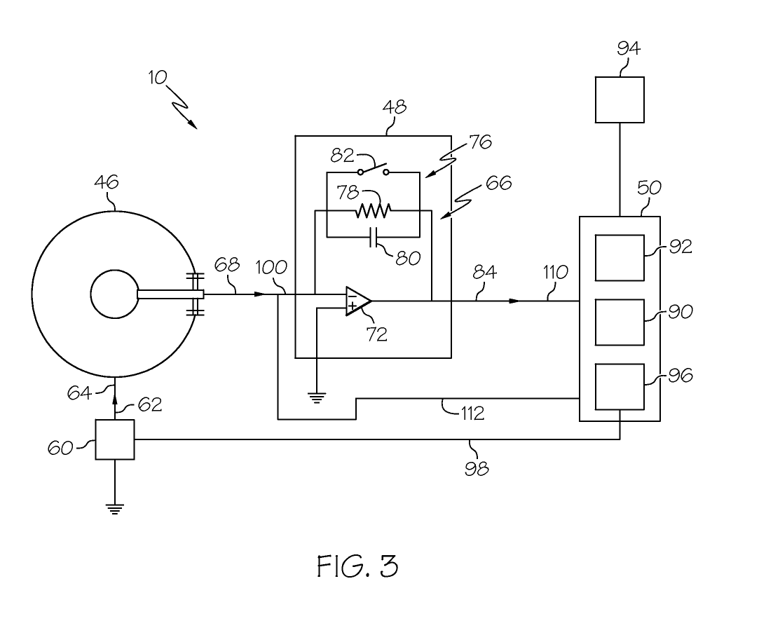

Turning to FIG. 3, an electrical schematic of an example environmental radiation monitor 10 is shown. The environmental radiation monitor 10 includes a power supply 60. The power supply may be the power supply within the enclosure 18 (best seen in FIG. 1) and/or a separate power component that is provided with power therefrom. The power supply 60 is electrically connected to the high pressure ionization chamber 46 through line 62, providing an input voltage signal 64. The power supply 60 can be located exterior to the enclosure 40 (best seen in FIG. 2) or within the interior volume 44 of the enclosure 40.

The electrometer 66 is electrically connected to the high pressure ionization chamber 46 through line 68 which can pass a signal from the high pressure ionization chamber 46 to the electrometer 66. During typical operation, the high pressure ionization chamber 46 creates a signal proportional to the amount of gamma radiation passing into the high pressure ionization chamber 46. The signal can be of relatively small magnitude. In one example, the signal is about 1×10⁻¹¹ amperes (amps). In another example, the signal is about 1×10⁻¹³ amps.

The electrometer 66 includes an operational amplifier (op amp) 72, which is one example of an electrical amplifier. The op amp 72 receives the signal from the high pressure ionization chamber 46, and converts the signal to an analog voltage signal that is readable by a controller 50. The electrometer 66 includes a compensation circuit 76 electrically connected to the op amp 72. In one example, the compensation circuit 76 can include a resistor 78, a capacitor 80, and a switch 82 electrically connected in parallel. While the compensation circuit 76 in FIG. 3 shows one sub-circuit including a resistor 78, a capacitor 80, and a switch 82 electrically connected in parallel, it is to be appreciated that other arrangements are also contemplated. For example, a plurality of sub-circuits each including a resistor, a capacitor, and a switch can be electrically connected so that each sub-circuit is electrically connected in parallel to every other sub-circuit. As mentioned, the electrometer 66 can be contained within an electrometer enclosure 48.

The electrometer 66 can be electrically connected to the controller 50 by line 84. The controller 50 processes the analog signal output from the electrometer 66 in any number of ways. In one example, an analog to digital converter within the controller 50 can convert the analog signal to a digital signal. A microprocessor 90 can then receive the digital signal and carry-out any necessary corrections to the digital signal. The corrected digital signal can then be placed in electronic memory 92 for retrieval at a later time through a suitable output 94. One example output can be a standard weather-tight port located on the protective enclosure 40 (best seen in FIG. 2). Alternatively, the corrected digital voltage signal can be transmitted to another location via other example outputs 94, such as a two-way communication system for example, an antenna, a satellite dish, etc.

It is difficult to test the operation/responsiveness of the electrometer 66 once it is installed in the environmental radiation monitor 10. Due to the relatively low magnitude of the currents used in the environmental radiation monitor 10 circuitry, there are few suitable options for reliably injecting such a small current amount into the electrometer 66 for a test operation. These testing difficulties are present in both laboratory and field deployment locations of the environmental radiation monitor 10. For example, a device configured to inject a relatively low magnitude current signal into the electrometer 66 could be included in the environmental radiation monitor 10. However, the added circuitry can create the possibility of leakage currents that make this option impractical. Additionally, environmental factors such as temperature greatly influence the test current signal at such low magnitude currents. In another example, laboratory devices used to create such low magnitude current signals can be relatively expensive.

An apparatus and methods for creating a reliable, low magnitude current to inject into the electrometer 66 for testing purposes is described. The internal configuration of the high pressure ionization chamber 46 enables it to act as a capacitor. In one example, the high pressure ionization chamber 46 can be configured as a sphere 10-inches in diameter with a central inner anode that is 2-inches in diameter resulting in a capacitance of the assembled device of about 8 picofarads. When a voltage signal is applied to a capacitor, it produces a current governed by the relationship I=C×(dV/dt) where I is the current output, C is the capacitance of the device, and (dV/dt) is the rate of change of the input voltage. Therefore, if a voltage signal applied to the capacitor is ramped at a constant rate, the (dV/dt) portion of the equation becomes a constant. As a result, if the capacitance of the capacitor remains constant, the resulting current signal produced by the capacitor will be of constant magnitude.

Using this relationship, end users can determine whether the electrometer 66 is properly functioning by utilizing a test function 96 operable by the controller 50 within the environmental radiation monitor 10. The test function 96 is configured to control the input voltage signal 64 provided to the high pressure ionization chamber 46. Line 98 can provide a path for a control signal from the test function 96 to the power supply 60. According to the above equation governing the current ouput of the high pressure ionization chamber 46, the test function 96 can control the input voltage signal 64 from the power supply 60 to produce a predetermined current signal 100 provided by the high pressure ionization chamber 46. In one example, the test function 96 can control the power supply 60 to produce a linear, ramping input voltage signal 64 in order to produce a current signal 100 having a constant current. In a more particular example, the test function 96 can control the power supply 60 to linearly ramp the input voltage signal 64 from 0 to 100 volts at a fixed rate during a testing operation.

Utilizing an accurately ramped input voltage signal 64 as an input, the high pressure ionization chamber 46 tends to produce a reliable current signal 100 having a relatively small magnitude current, similar to the small magnitude currents produced by the high pressure ionization chamber 46 during typical operation. These small magnitude currents are preferred for testing the response of the electrometer 66. Line 68 carries the current signal 100 to the electrometer 66 where the current signal 100 is converted to a readable output voltage signal 110. The resultant output voltage signal 110 is governed by the relationship of V=I×R where V represents the output voltage signal 110, I represents the current signal 100, and R represents the resistance of the electrometer 66.

The controller 50 can measure the current signal 100 through line 112 in order to determine if the current signal 100 has a constant current. Because the resistance value of the electrometer 66 is a known constant and the current signal 100 also has a constant value as measured by the controller 50, the output voltage signal 110 is expected to have a predictable constant value. The controller can evaluate the voltage value of the output voltage signal 110 proceeding along line 84 to determine if the electrometer 66 has the proper, expected response.

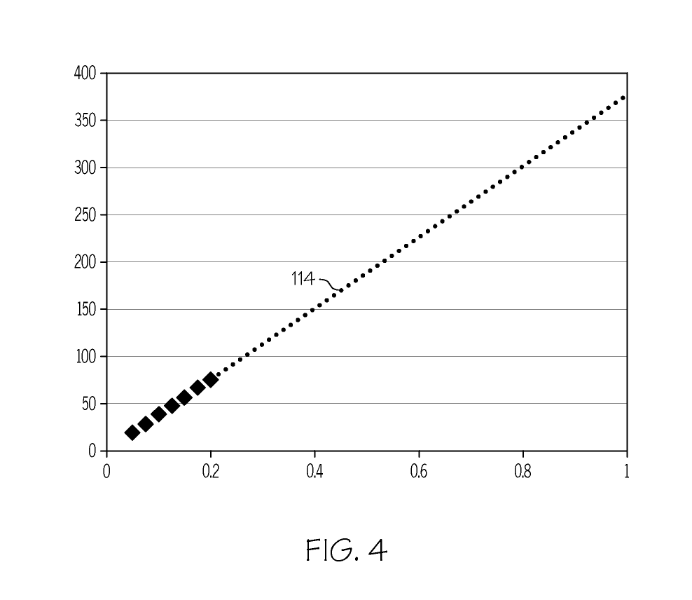

Turning to FIG. 4, plot 114 shows the resulting current signal output behavior of an example electrometer 66 in response to various ramp rates of the input voltage signal 64 supplied to the high pressure ionization chamber 46. The horizontal X-axis represents the ramp rate of the input voltage signal 64 supplied to the high pressure ionization chamber 46 by an example power supply 60 measured in volts per second. The vertical Y-axis represents output of the example electrometer 66 measured in millivolts. As shown, one particular ramp rate of the input voltage signal 64 produces a constant output voltage signal 110. The diamond-shaped points of plot 114 represent actual measured values during testing while the dotted portion of plot 114 represents predicted values. In one example, the output of the example electrometer can take the form A×input voltage signal ramp rate+B, where A and B are constants.

Returning to FIG. 3, in the event that results of the test function 96 indicate the electrometer 66 no longer has the proper, expected response, the electrometer may have to be replaced. In one example, a service technician can be dispatched to be physically present to replace the electrometer 66. In yet another example, the environmental radiation monitor 10 can be removed and shipped to a service facility for replacement of the electrometer 66.

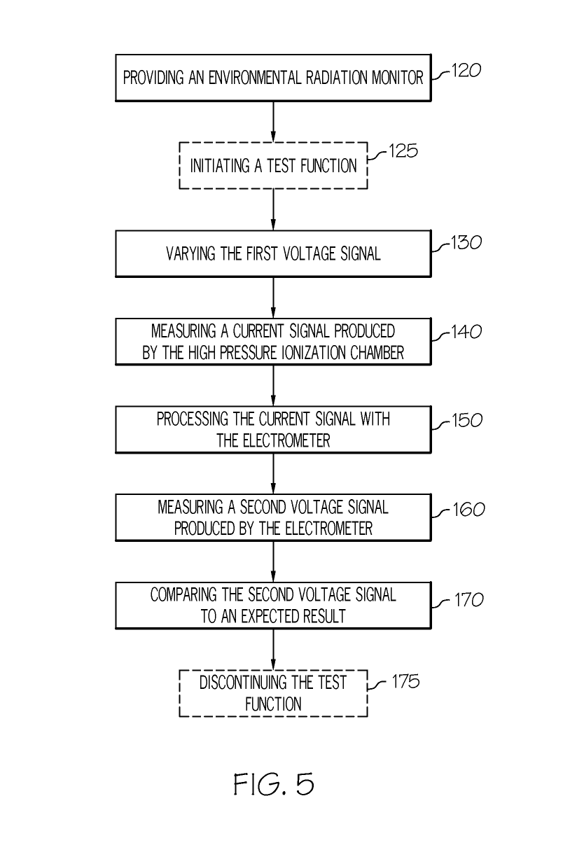

An example method of conducting a test cycle for an electrometer 66 for an environmental radiation monitor 10 is generally described in FIG. 5. The method can be performed in connection with the example environmental radiation monitor 10 shown in FIGS. 2 and 3. The method includes the step 120 of providing an environmental radiation monitor 10. The environmental radiation monitor 10 includes a high pressure ionization chamber 46 and a power supply 60 electrically connected to the high pressure ionization chamber 46. The power supply 60 is configured to provide an input voltage signal 64 to the high pressure ionization chamber 46. The environmental radiation monitor 10 also includes an electrometer 66 electrically connected to the high pressure ionization chamber 46. The environmental radiation monitor 10 further includes a controller 50 electrically connected to the power supply 60 and the electrometer 66. The controller 50 is configured to control the power supply 60 input voltage signal 64 provided to the high pressure ionization chamber 46.

In one example of the method, the test cycle for an electrometer can include the step 125 of initiating a test function 96. The test function 96 can be initiated by any number of suitable means including, but not limited to, a signal from the controller 50, a signal from a remote location, and a manual initiation by an operator present at the environmental radiation monitor 10. Once the test function 96 has been initiated, the test function 96 requires the controller 50 to process a set of incoming data differently than when the test function 96 is not initiated. In one example, the output voltage signal 110 data received by the controller 50 during the test function 96 is saved in a memory location, transmitted, or otherwise processed separately from the output voltage signal 110 data received during normal operation. Data saved during initiation of the test function 96 can be retrieved at a later time. Processing the incoming data differently during the test function 96 minimizes the possibility of confusing the electrometer 66 test data with regularly collected data indicating the presence of gamma radiation.

The method further includes the step 130 of varying the input voltage signal 64 provided to the high pressure ionization chamber 46. In one example, the input voltage signal 64 can be ramped at a constant rate and provided to the high pressure ionization chamber 46 which, in turn, produces a current signal 100 having a constant current value. In one particular example, varying the input voltage signal includes linearly ramping the power supply 60 input voltage signal 64 from 0 to 100 volts at a constant rate.

The method also includes the step 140 of measuring the current signal 100 produced by the high pressure ionization chamber 46. As mentioned, the controller 50 can measure the current signal 100 through line 112 in order to determine if the current signal 100 has a constant current. The method further includes the step 150 of processing the current signal 100 with the electrometer 66. As mentioned, line 68 carries the current signal 100 to the electrometer 66 where the current signal 100 is converted to a readable output voltage signal 110. The resultant output voltage signal 110 is governed by the relationship of V=I×R where V represents the output voltage signal 110, I represents the current signal 100, and R represents the resistance of the electrometer 66.

The method also includes the step 160 of measuring an output voltage signal 110 produced by the electrometer 66. The microprocessor 90 within the controller 50 can measure the output voltage signal 110 provided to the controller 50 via line 112. Because the resistance value of the electrometer 66 is a known constant and the current signal 100 also has a constant value as measured by the controller 50, the output voltage signal 110 is expected to have a predictable constant voltage.

The method further includes the step 170 of comparing the output voltage signal 110 to an expected result which can be predetermined by software within the microprocessor 90. Comparisons yielding an output voltage signal 110 having a voltage that is the same or is very nearly the same to the expected voltage based on the ramped input voltage signal 64 indicates proper operation of the electrometer 66. Comparisons yielding a relatively large difference between the output voltage signal 110 and the expected voltage can indicate poor response from the electrometer 66.

In one example of the method, the test cycle for an electrometer 66 can include the step 175 of discontinuing the test function 96. Termination of the test function 96 will permit the controller 50 to treat incoming data as actual gamma radiation detection data that can be placed in electronic memory 92 for retrieval at a later time through a suitable output 94. One example output can be a standard weather-tight port located on the protective enclosure 40 (best seen in FIG. 2). Alternatively, the corrected digital voltage signal can be transmitted to another location via other example outputs 94, such as a two-way communication system for example, an antenna, a satellite dish, etc.

Testing of the electrometer 66 included within an environmental radiation monitor 10 can occur in the field according to the method steps described above. However, it is also desirable from time to time to test the electrometer outside of its typical installation within an environmental radiation monitor 10. For example, the electrometer 66 may be tested in a laboratory setting prior to installation in the environmental radiation monitor 10 to help ensure proper operation/responsiveness prior to delivery to an end customer. On the bench top, the electrometer 66 can be tested without a controller 50 and a test function 96 with a similar method as that described above. In this example of the method, the test cycle for an electrometer 66 can proceed directly from step 120 to step 130 to eliminate step 125 as shown in FIG. 5. Step 175 can also be eliminated in this example of the method.

In further examples of the method, the test function 96 of the controller 50 is configured to vary the power supply 60 input voltage signal 64. In one particular example, the test function 96 of the controller 50 is configured to vary the power supply 60 input voltage signal 64. The controller 50 can vary the input voltage signal 64 by ramping the power supply 60 input voltage signal 64 linearly. In a more particular example, the controller 50 can vary the input voltage signal 64 by linearly ramping the power supply 60 input voltage signal 64 from 0 to 100 volts at a constant rate.

In the described examples, the methods and apparatus provide a relatively inexpensive means of helping to ensure that data obtained from the environmental radiation monitor 10 is accurate by providing a reliable test for proper response from the electrometer 66. The described methods and apparatus provide a simplified testing of electrometer 66 operation/responsiveness in environmental radiation monitors 10 by injecting current from a high pressure ionization chamber 46. The method and apparatus can help the end user of the environmental radiation monitor 10 remotely test for proper response from the electrometer 66 and receive electrometer 66 test results in a relatively short time.

The invention has been described with reference to the example embodiments described above. Modifications and alterations will occur to others upon a reading and understanding of this specification. Example embodiments incorporating one or more aspects of the invention are intended to include all such modifications and alterations insofar as they come within the scope of the appended claims.

What is claimed is:

1. An environmental radiation monitor including:
a high pressure ionization chamber;
a power supply electrically connected to the high pressure ionization chamber, wherein the power supply is configured to provide an input voltage signal to the high pressure ionization chamber;
an electrometer electrically connected to the high pressure ionization chamber; and
a controller electrically connected to the power supply and the electrometer, wherein the controller is configured to control the power supply input voltage signal provided to the high pressure ionization chamber.

2. The environmental radiation monitor according to claim 1, wherein the controller further includes a test function.

3. The environmental radiation monitor according to claim 2, wherein the test function of the controller is configured to vary the power supply input voltage signal.

4. The environmental radiation monitor according to claim 3, wherein the test function of the controller is configured to linearly ramp the power supply input voltage signal.

5. The environmental radiation monitor according to claim 4, wherein the test function of the controller is configured to linearly ramp the power supply input voltage signal from 0 to 100 volts at a constant rate.

6. A method of conducting a test cycle for an electrometer of an environmental radiation monitor including:
providing an environmental radiation monitor including a high pressure ionization chamber, a power supply electrically connected to the high pressure ionization chamber, wherein the power supply is configured to provide an input voltage signal to the high pressure ionization chamber, an electrometer electrically connected to the high pressure ionization chamber, and a controller electrically connected to the power supply and the electrometer, wherein the controller is configured to control the power supply input voltage signal provided to the high pressure ionization chamber;
varying the input voltage signal provided to the high pressure ionization chamber;
measuring a current signal produced by the high pressure ionization chamber;
processing the current signal with the electrometer;
measuring an output voltage signal produced by the electrometer; and
comparing the output voltage signal to an expected result, wherein the comparison indicates proper operation of the electrometer.

7. The method according to claim 6, wherein the controller further includes a test function.

8. The method according to claim 7, wherein the test function of the controller is configured to vary the power supply input voltage signal.

9. The method according to claim 8, wherein the step of varying the input voltage signal includes ramping the power supply input voltage signal linearly.

10. The method according to claim 9, wherein the step of varying the input voltage signal includes linearly ramping the power supply input voltage signal from 0 to 100 volts at a constant rate.

11. A method of conducting a test cycle for an electrometer of an environmental radiation monitor including:
providing an environmental radiation monitor including a high pressure ionization chamber, a power supply electrically connected to the high pressure ionization chamber, wherein the power supply is configured to provide an input voltage signal to the high pressure ionization chamber, an electrometer electrically connected to the high pressure ionization chamber, and a controller electrically connected to the power supply and the electrometer, wherein the controller includes a test function and is configured to control the power supply input voltage signal provided to the high pressure ionization chamber;
initiating the test function, wherein the test function requires the controller to process a set of incoming data differently than when the test function is not initiated;
varying the input voltage signal provided to the high pressure ionization chamber;
measuring a current signal produced by the high pressure ionization chamber;
processing the current signal with the electrometer;
measuring an output voltage signal produced by the electrometer;
comparing the output voltage signal to an expected result, wherein the comparison indicates proper operation of the electrometer; and
discontinuing the test function.

12. The method according to claim 11, wherein the test function is configured to vary the power supply input voltage signal.

13. The method according to claim 12, wherein the step of varying the input voltage signal includes ramping the power supply input voltage signal linearly.

14. The method according to claim 13, wherein the step of varying the input voltage signal includes linearly ramping the power supply input voltage signal from 0 to 100 volts at a constant rate.
